(19) United States
(12) Patent Application Publication
(10) Pub. No.: US 2026/0153923 A1
(43) Pub. Date: Jun. 4, 2026

(54) SELECTING OPTIONS ON A SCREEN USING GESTURES

(71) Applicant: eBay Inc., San Jose, CA (US)

(72) Inventor: Shrivatsan Navalpakkam Rajagopalan, San Jose, CA (US)

(21) Appl. No.: 18/968,013

(22) Filed: Dec. 4, 2024

(51) Int. Cl. G06F 3/01; G06F 3/16

(52) U.S. Cl. CPC G06F 3/012; G06F 3/013; G06F 3/167

(57) ABSTRACT

A system is provided that adjusts a setting using user motion. The system displays a setting on a screen having a value adjustable based on user input and receives, from a head-worn device, first data that indicates activation of the setting to enable the setting to be adjusted. The system receives, from the head-worn device, motion information associated with a body part of a user of the head-worn device and adjusts the value of the setting based on the motion information. The system receives, from the head-worn device, second data indicative of a verbal cue from the user to confirm the adjusted value and detects a pattern of movement associated with the body part of the user concurrently with receiving the second data. The system causes the adjusted value to be stored in association with the setting based on receiving the second data and detecting the pattern of movement.

### TECHNICAL FIELD

The subject matter disclosed herein generally relates to a special-purpose machine that includes a system for providing accessible content publication management services for users with dexterity impairments, including computerized variants of such special-purpose machines and improvements to such variants, and to the technologies by which such special-purpose machines become improved compared to other special-purpose machines.

### BACKGROUND

E-commerce platforms provide sellers with a structured process for creating product listings and managing their advertising options. The listing creation process generally begins with the seller accessing their account dashboard and selecting an option to add a new product. From there, they are guided through a series of steps that involve inputting product information. This usually includes the product title, description, price, quantity available, and shipping details. Sellers are often required to upload high-quality images of their product and may have the option to add videos or 360-degree views. Additionally, they need to select appropriate categories and add relevant keywords or tags.

### SUMMARY

In some aspects, the techniques described herein relate to a system including: one or more hardware processors; and at least one machine-storage medium for storing instructions that, when executed by the one or more hardware processors, cause the one or more hardware processors to perform operations including: displaying a setting on a screen, the setting having a value that is adjustable based on user input; receiving, from a head-worn device, first data that indicates activation of the setting to enable the setting to be adjusted; receiving, from the head-worn device, motion information associated with a body part of a user of the head-worn device; adjusting the value of the setting based on the motion information; receiving, from the head-worn device, second data indicative of a verbal cue from the user to confirm the adjusted value; detecting a pattern of movement associated with the body part of the user concurrently with receiving the second data; and causing the adjusted value to be stored in association with the setting based on receiving the second data and detecting the pattern of movement.

In some aspects, the techniques described herein relate to a system, wherein the operations include: automatically generating a listing for an item in a field of view of the head-worn device; publishing the listing on a publication platform, wherein the setting includes a rate selection for setting a rate for publishing the listing on the publication platform; presenting a first option to increase the value of the setting; presenting a second option to decrease the value for the setting; and selecting between the first option and the second option based on the motion information.

In some aspects, the techniques described herein relate to a system, wherein the body part includes a head of the user, and wherein the operations include: determining, based on the motion information, that the head of the user is being moved in a first direction; and in response to determining, based on the motion information, that the head of the user is being moved in the first direction, increasing the value of the setting.

In some aspects, the techniques described herein relate to a system, wherein the operations include: identifying a central axis relative to the head-worn device; determining that a normal of the head-worn device is being raised by the head above the central axis by a threshold amount followed by being returned to being aligned with the central axis; in response to determining that the normal of the head-worn device is being raised by the head above the central axis by the threshold amount followed by being returned to being aligned with the central axis, increasing the value of the setting a first time; determining that the normal of the head-worn device is again being raised by the head above the central axis by the threshold amount followed by being returned to being aligned with the central axis; and in response to determining that the normal of the head-worn device is again being raised by the head above the central axis by the threshold amount followed by being returned to being aligned with the central axis, increasing the value of the setting a second time.

In some aspects, the techniques described herein relate to a system, wherein the operations include: determining that the motion information represents a double nod of the head, the double nod of the head including moving the head above or below the central axis a certain number of times within a specified interval; and in response to determining that the motion information represents the double nod of the head, storing the adjusted value for the setting after receiving the verbal cue.

In some aspects, the techniques described herein relate to a system, wherein the operations include: presenting audible feedback to the user indicating the adjusted value; and receiving the verbal cue confirming the adjusted value following the audible feedback.

In some aspects, the techniques described herein relate to a system, wherein the body part includes eyes of the user, and wherein the operations include: determining, based on the motion information, that the eyes of the user are being moved in a first direction; and in response to determining, based on the motion information, that the eyes of the user are being moved in the first direction, increasing the value of the setting.

In some aspects, the techniques described herein relate to a system, wherein the operations include: identifying a central axis relative to the head-worn device; determining that a normal of the eyes is being raised above the central axis by a threshold amount followed by being returned to being aligned with the central axis; in response to determining that the normal of the eyes is being raised above the central axis by the threshold amount followed by being returned to being aligned with the central axis, increasing the value of the setting a first time; determining that the normal of the eyes is again being raised above the central axis by the threshold amount followed by being returned to being aligned with the central axis; and in response to determining that the normal of the eyes is again being raised above the central axis by the threshold amount followed by being returned to being aligned with the central axis, increasing the value of the setting a second time.

In some aspects, the techniques described herein relate to a system, wherein the operations include: determining that a blinking pattern of the eyes corresponds to a specified pattern; and in response to determining that the blinking pattern of the eyes corresponds to the specified pattern, storing the adjusted value for the setting after receiving the verbal cue.

In some aspects, the techniques described herein relate to a system, wherein the operations include: applying a combination of object segmentation and, haptic and verbal cues to activate the setting for adjustment.

In some aspects, the techniques described herein relate to a system, wherein the pattern of movement includes a double nod of a head, where the head is moved up and down multiple times within a specified threshold period of time.

In some aspects, the techniques described herein relate to a system, wherein the verbal cue includes one or more nonverbal sounds.

In some aspects, the techniques described herein relate to a method including: displaying, by one or more hardware processors, a setting on a screen, the setting having a value that is adjustable based on user input; receiving, from a head-worn device, first data that indicates activation of the setting to enable the setting to be adjusted; receiving, from the head-worn device, motion information associated with a body part of a user of the head-worn device; adjusting the value of the setting based on the motion information; receiving, from the head-worn device, second data indicative of a verbal cue from the user to confirm the adjusted value; detecting a pattern of movement associated with the body part of the user concurrently with receiving the second data; and causing the adjusted value to be stored in association with the setting based on receiving the second data and detecting the pattern of movement.

In some aspects, the techniques described herein relate to a method, further including: automatically generating a listing for an item in a field of view of the head-worn device; publishing the listing on a publication platform, wherein the setting includes a rate selection for setting a rate for publishing the listing on the publication platform; presenting a first option to increase the value of the setting; presenting a second option to decrease the value for the setting; and selecting between the first option and the second option based on the motion information.

In some aspects, the techniques described herein relate to a method, wherein the body part includes a head of the user, and further including: determining, based on the motion information, that the head of the user is being moved in a first direction; and in response to determining, based on the motion information, that the head of the user is being moved in the first direction, increasing the value of the setting.

In some aspects, the techniques described herein relate to a method, further including: identifying a central axis relative to the head-worn device; determining that a normal of the head-worn device is being raised by the head above the central axis by a threshold amount followed by being returned to being aligned with the central axis; in response to determining that the normal of the head-worn device is being raised by the head above the central axis by the threshold amount followed by being returned to being aligned with the central axis, increasing the value of the setting a first time; determining that the normal of the head-worn device is again being raised by the head above the central axis by the threshold amount followed by being returned to being aligned with the central axis; and in response to determining that the normal of the head-worn device is again being raised by the head above the central axis by the threshold amount followed by being returned to being aligned with the central axis, increasing the value of the setting a second time.

In some aspects, the techniques described herein relate to a method, further including: determining that the motion information represents a double nod of the head, the double nod of the head including moving the head above or below the central axis a certain number of times within a specified interval; and in response to determining that the motion information represents the double nod of the head, storing the adjusted value for the setting after receiving the verbal cue.

In some aspects, the techniques described herein relate to a method, further including: presenting audible feedback to the user indicating the adjusted value; and receiving the verbal cue confirming the adjusted value following the audible feedback.

In some aspects, the techniques described herein relate to a method, wherein the body part includes eyes of the user, and further including: determining, based on the motion information, that the eyes of the user are being moved in a first direction; and in response to determining, based on the motion information, that the eyes of the user are being moved in the first direction, increasing the value of the setting.

In some aspects, the techniques described herein relate to a machine-storage medium for storing instructions that, when executed by one or more hardware processors, cause the one or more hardware processors to perform operations including: displaying a setting on a screen, the setting having a value that is adjustable based on user input; receiving, from a head-worn device, first data that indicates activation of the setting to enable the setting to be adjusted; receiving, from the head-worn device, motion information associated with a body part of a user of the head-worn device; adjusting the value of the setting based on the motion information; receiving, from the head-worn device, second data indicative of a verbal cue from the user to confirm the adjusted value; detecting a pattern of movement associated with the body part of the user concurrently with receiving the second data; and causing the adjusted value to be stored in association with the setting based on receiving the second data and detecting the pattern of movement.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some examples.

FIG. 2 is a block diagram illustrating examples of applications that, in one example, are provided as part of a networked system, in accordance with some examples.

FIG. 3 illustrates a routine for enabling option selection, in accordance with some examples.

FIG. 4 is a block diagram illustrating a representative software architecture, which may be used in conjunction with various hardware architectures herein described, in accordance with some examples.

FIG. 5 is a diagrammatic representation of a machine in the form of a computer system within which a set of instructions may be executed for causing the machine to perform any one or more of the methodologies discussed herein, in accordance with some examples.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

As mentioned above, listing creation for e-commerce platforms involves many steps. The listing creation process generally begins with the seller accessing their account dashboard and selecting an option to add a new product. From there, they are guided through a series of steps that involve inputting product information. Once the basic listing is complete, sellers are presented with various options to enhance visibility and sales potential. This may include choosing to participate in promotional programs, setting up volume discounts, or configuring tax and return policies.

One aspect of this process is setting up advertising parameters. Sellers have the option to create sponsored listings or pay-per-click advertisements. This involves selecting an advertising budget, determining bid amounts for keywords, and choosing the duration of the campaign. Throughout this process, sellers encounter numerous dropdown menus, toggle switches, radio buttons, and text input fields, all of which require precise interactions that can be challenging for those with dexterity impairments. As a result, sellers may spend an inordinate amount of time navigating these interfaces, leading to decreased productivity and increased frustration. This inefficiency can result in fewer listings being created or updated, potentially reducing the seller's market presence and revenue.

The complexity of setting advertising parameters, combined with the physical challenges of interacting with the interface, can lead to suboptimal decision-making. Sellers may rush through the process, selecting default options or making hasty choices to avoid prolonged interaction with difficult controls. This can result in ineffective advertising campaigns, where budgets are misallocated, bid amounts are set inappropriately, or campaign durations are not optimized. Consequently, sellers may waste financial resources on poorly configured advertisements that fail to reach their target audience or generate desired returns.

In addition, for sellers with dexterity impairments, the process of creating sponsored listings or configuring pay-per-click advertisements can be exhausting and time-consuming. The extra effort required to interact with challenging interfaces diverts time and energy from other aspects of their business, such as product development, customer service, or strategic planning. This misallocation of personal resources can hinder overall business growth and competitiveness in the marketplace. The combination of complex decision-making and difficult-to-use interfaces increases the likelihood of errors in advertising setup. Sellers may accidentally select incorrect options, input inaccurate bid amounts, or choose inappropriate keywords due to the challenges of precise interaction. These errors can lead to wasted ad spend, missed opportunities, and potentially harmful effects on the seller's reputation if ads are displayed in unintended contexts.

The effect of these inefficiencies creates a significant barrier to market entry and expansion for sellers with dexterity impairments. The daunting nature of the advertising setup process may discourage some sellers from utilizing these features altogether, putting them at a competitive disadvantage. For those who do attempt to use these tools, the increased time and effort required may limit their ability to rapidly respond to market changes or scale their advertising efforts in line with business growth. By inadvertently excluding or limiting the participation of sellers with dexterity impairments, platforms may be reducing the diversity of products available and potentially missing out on innovative offerings that could attract more customers. This inefficiency affects not just individual sellers, but the overall ecosystem of the e-commerce platform.

The present application describes a novel system that addresses these technical challenges. The disclosed techniques display a setting on a screen having a value adjustable based on user input and receive, from a head-worn device, first data that indicates activation of the setting to enable the setting to be adjusted. The disclosed techniques receive, from the head-worn device, motion information associated with a body part of a user of the head-worn device and adjust the value of the setting based on the motion information. The disclosed techniques receive, from the head-worn device, second data indicative of a verbal cue from the user to confirm the adjusted value and detect a pattern of movement associated with the body part of the user concurrently with receiving the second data. The disclosed techniques cause the adjusted value to be stored in association with the setting based on receiving the second data and detecting the pattern of movement.

For example, a user can wear a head-worn device, such as augmented reality (AR) glasses or other suitable equipment. The user can focus their attention on a particular option that is presented on a display. The head-worn device can detect what option is being displayed and receive a verbal cue or other input (e.g., motion) confirming that the option is the intended target that the user is interested in selecting/modifying. In response, the head-worn device communicates with the computing device that displays the option and instructs the computing device to activate the option. The head-worn device detects motion of the user's head in a particular direction (e.g., the user may move their head up) or detects movement of the pupils in the particular direction. In such cases, the head-worn device instructs the computing device to increment the value of the selected option or navigate a scrollable list of menu items in the particular direction. Similarly, the head-worn device detects motion of the user's head in an opposite direction (e.g., the user may move their head down) or detects movement of the pupils in the opposite direction. In such cases, the head-worn device instructs the computing device to decrement the value of the selected option or navigate a scrollable list of menu items in the opposite direction. Once a desired menu item or option adjustment is reached, the head-worn device can detect a verbal cue coupled with a predetermined pattern of motion. This can be detected once a confirmation prompt is presented audibly or visually to the user. For example, the head-worn device can detect a nonverbal input (e.g., “mmhmm”) coupled with a double nod of the head (e.g., movement repetitively in an up and down manner within a threshold period of time, such as two seconds). In response, the head-worn device can instruct the computing device to store the selected setting for the option. In this way, users with dexterity issues can easily interact with the computing device and generate listings along with modifying their respective options. This improves the overall user experience and addresses the above challenges.

As a result, one or more of the methodologies described herein facilitate solving the technical problem of selecting screen options and navigating interfaces presented by conventional methods. As such, one or more of the methodologies described herein may obviate a need for certain efforts or computing resources that otherwise would be involved in navigating interfaces and selecting screen options. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

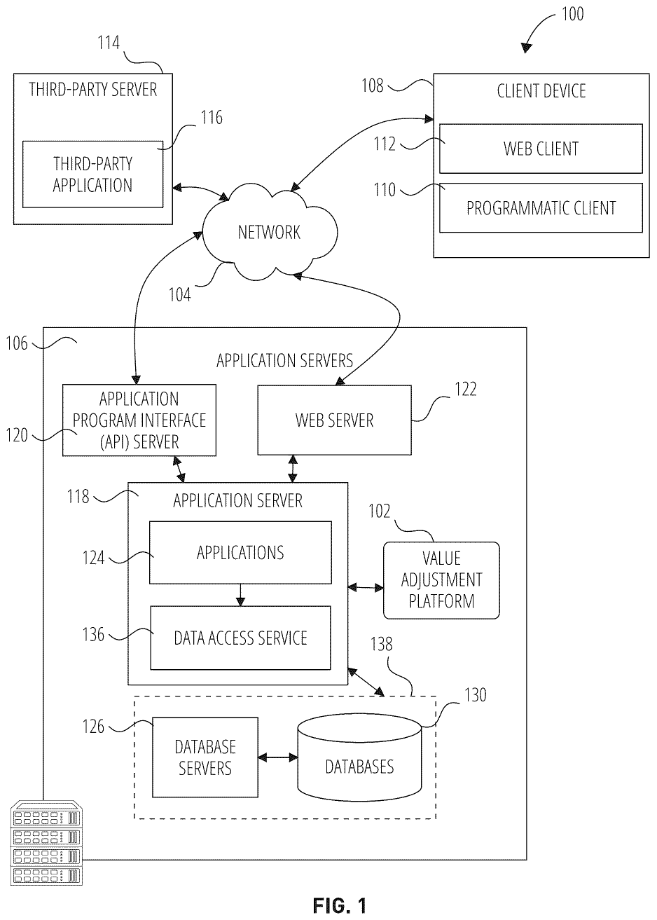

FIG. 1 is a diagrammatic representation of a network environment 100 in which some examples of the present disclosure may be implemented or deployed. One or more application servers 106 provide server-side functionality via a network 104 to a networked user device, in the form of a client device 108. A web client 112 (e.g., a browser) and a programmatic client 110 (e.g., an “app”) are hosted and execute on the web client 112.

An Application Program Interface (API) server 120 and a web server 122 provide respective programmatic and web interfaces to application servers 106. A specific application server 118 hosts an applications 124 and a data access service 136, which includes components, modules, and/or applications.

The applications 124 may provide a number of functions and services to users who access the application servers 106. For example, the applications 124 may include a publication application that enables users to publish content (e.g., product item information) on a hosted web page. While the applications 124 is shown in FIG. 1 to be part of the application servers 106, it will be appreciated that, in alternative examples, the applications 124 may be separate and distinct from the application server 118. The applications 124 can also enable buyers to purchase items from an online electronic commerce platform where users can buy and sell physical (tangible) and/or intangible items.

The data access service 136 coordinates requests from the applications 124 to access services provided by value adjustment platform 102 and to access data stored in one or more cache nodes and/or databases 130 (e.g., database servers 126) of data access layer 138. For example, the data access service 136 coordinates transaction requests from the applications 124 across distributed database servers of the value adjustment platform 102.

Further, while the network environment 100 shown in FIG. 1 employs a client-server architecture, the examples are, of course, not limited to such an architecture, and could equally well find application in a distributed, or peer-to-peer, architecture system. The applications 124 could also be implemented as a standalone software program, which do not necessarily have networking capabilities.

The web client 112 accesses the applications 124 via the web interface supported by the web server 122. Similarly, the programmatic client 110 accesses the various services, microservices, and functions provided by the applications 124 via the programmatic interface provided by the Application Program Interface (API) server 120. In one example, the programmatic client 110 may, for example, be a seller application (e.g., eBay Application developed by eBay Inc., of San Jose, California) to enable sellers to author and manage listings on the network environment 100 in an offline manner, and to perform batch-mode communications between the programmatic client 110 and the application servers 106. In one example, the programmatic client 110 may, for example, be a buyer (purchaser) application (e.g., eBay Application developed by eBay Inc., of San Jose, California) to enable buyers to search available listings for items on the network environment 100 in an online manner, to select items to purchase, and to perform batch-mode communications between the programmatic client 110 and the application servers 106.

FIG. 1 also illustrates a third-party application 116 executing on a third-party server 114 as having programmatic access to the application servers 106 via the programmatic interface provided by the Application Program Interface (API) server 120. For example, the third-party application 116 may, utilizing information retrieved from the application server 118, support one or more features or functions on a website hosted by a third party. The third-party website may, for example, provide one or more promotional, marketplace, or payment functions that are supported by the relevant applications of the application servers 106.

Any of the systems or machines (e.g., databases, devices, servers) shown in, or associated with, FIG. 1 may be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 108 may be embodied within the network environment 100. Furthermore, some components or functions of the network environment 100 may be combined or located elsewhere in the network environment 100. For example, some of the functions of the client device 108 may be embodied at the application server 118.

The value adjustment platform 102 can display a setting on a screen having a value adjustable based on user input and receive, from a head-worn device, first data that indicates activation of the setting to enable the setting to be adjusted. The value adjustment platform 102 receives, from the head-worn device, motion information associated with a body part of a user of the head-worn device and adjusts the value of the setting based on the motion information.

The value adjustment platform 102 receives, from the head-worn device, second data indicative of a verbal cue from the user to confirm the adjusted value and detects a pattern of movement associated with the body part of the user concurrently with receiving the second data. The value adjustment platform 102 causes the adjusted value to be stored in association with the setting based on receiving the second data and detecting the pattern of movement.

For example, a user can wear a head-worn device, such as AR glasses or other suitable equipment. The head-worn device can implement the value adjustment platform 102 alone or in combination with one or more other devices, such as client device 108. The user can focus their attention on a particular option that is presented on a display of the client device 108 and/or the head-worn device (e.g., AR glasses). The head-worn device can detect what option is being displayed (e.g., by analyzing content that is displayed on the screen and identifying buttons that resemble options). The head-worn device can receive a verbal cue or other input (e.g., motion) confirming that the option is the intended target that the user is interested in selecting/modifying. In response, the head-worn device communicates with the computing device (e.g., client device 108) that displays the option and instructs the computing device to activate the option.

The head-worn device detects motion of the user's head in a particular direction (e.g., the user may move their head up) or detects movement of the pupils in the particular direction. In such cases, the head-worn device instructs the computing device to increment the value of the selected option or navigate a scrollable list of menu items in the particular direction. Similarly, the head-worn device detects motion of the user's head in an opposite direction (e.g., the user may move their head down) or detects movement of the pupils in the opposite direction. In such cases, the head-worn device instructs the computing device to decrement the value of the selected option or navigate a scrollable list of menu items in the opposite direction. Once a desired menu item or option adjustment is reached, the head-worn device can detect a verbal cue coupled with a predetermined pattern of motion. This can be detected once a confirmation prompt is presented audibly or visually to the user. For example, the head-worn device can detect a nonverbal input (e.g., “mmhmm”) coupled with a double nod of the head (e.g., movement repetitively in an up and down manner within a threshold period of time, such as two seconds). In response, the head-worn device can instruct the computing device to store the selected setting for the option. In this way, users with dexterity issues can easily interact with the computing device and generate listings along with modifying their respective options. This improves the overall user experience and addresses the above challenges.

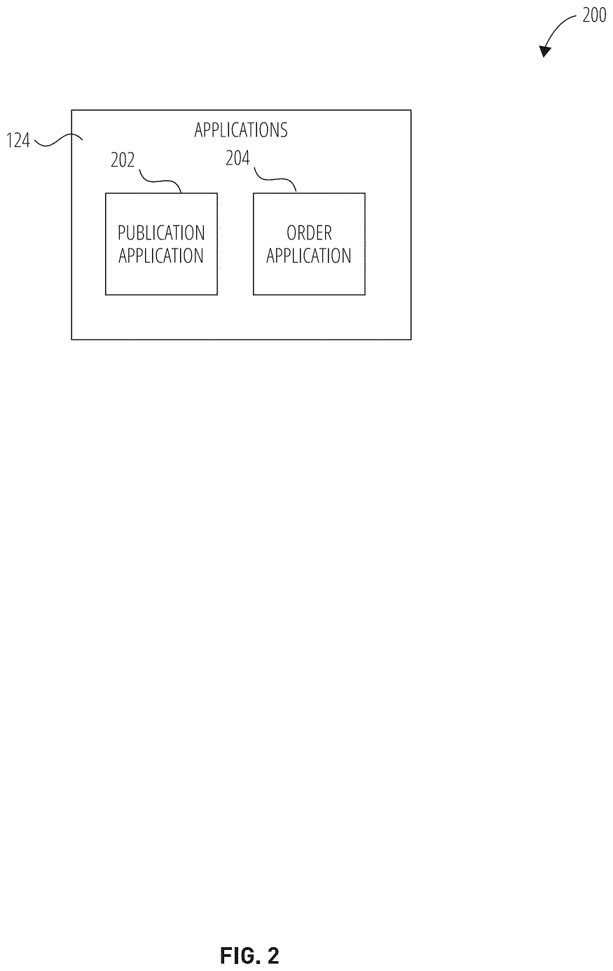

FIG. 2 is a block diagram 200 illustrating the applications 124 that, in one example, are provided as part of the network environment 100. The applications 124 may be hosted on dedicated or shared server machines (not shown) that are communicatively coupled to enable communications between or among server machines. The applications 124 themselves are communicatively coupled (e.g., via appropriate interfaces) to each other and to various data sources, so as to allow information to be passed between or among the applications 124 or so as to allow the applications 124 to share and access common data. The applications 124 may furthermore access one or more databases 130 via the database servers 126.

The application server 118 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the applications 124 is shown to include at least one publication application 202 and one or more order applications 204.

In some cases, the applications 124 can provide a graphical user interface (GUI) to a user. The GUI can enable a user to generate listings for the e-commerce application or electronic marketplace and adjust various settings for the listings. In some cases, the applications 124 can be implemented on the client device 108 and also on a head-worn device (e.g., AR glasses). In some cases, the applications 124 can be implemented on the head-worn device alone and used to communicate information to the web server 122 to generate listings for the electronic marketplace and modify options (e.g., an ad rate or advertising rate for a listing).

For example, a head-worn device (which can be part of the client device 108) can be worn by a user (e.g., a seller in an online marketplace). The head-worn device can implement one or more machine learning models that are trained to detect objects within view of lenses of the head-worn device. Namely, the head-worn device can include a front-facing camera and an artificial neural network that can segment and detect objects in frames of a video captured by the front-facing camera.

Machine learning is a field of study that gives computers the ability to learn without being explicitly programmed. Machine learning (e.g., machine learning models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained at machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

In some examples, as the head-worn device detects real-world objects in a real-world environment of the user, the head-worn device identifies the real-world objects (e.g., assigns unique names/values to the objects) and searches the applications 124 (e.g., databases 130) for listings corresponding to the identified real-world objects. For example, a user may be moving around a real-world environment and a physical desk can be detected by the trained machine learning model of the head-worn device. Using the applications 124, the head-worn device can search the databases 130 to determine whether a listing by another seller is available for the same physical desk. To do so, the head-worn device can analyze features of the identified real-world environment with features of images included as part of the listing on the electronic marketplace. In response to determining that the features correlate to each other or are similar within a threshold amount, the head-worn device determines that the listing corresponds to the identified real-world object. In such cases, the head-worn device presents a notification or prompt asking the user if the user is interested in having the head-worn device (using the applications 124) automatically generate a listing for the chair that is in the field of view of the head-worn device.

The head-worn device can monitor inputs of the user. For example, the head-worn device can determine whether a verbal cue (e.g., nonverbal voice information is received, such as “mmmhhm”) is received along with or concurrently with a pattern of movement of the head (e.g., a double nod). The double nod can be detected in a number of different ways. For example, the double head nod can be detected using a combination of sensors and algorithms implemented by the head-worn device. An Inertial Measurement Unit (IMU) of the head-worn device can detect head movements through the user of an accelerometer and a gyroscope. The accelerometer measures linear acceleration in three axes, while the gyroscope measures angular velocity. These sensors provide data about the head's orientation and movement in three-dimensional (3D) space.

The IMU continuously samples data at a high frequency, ranging from 100 Hz to 1000 Hz. This raw data is then passed through digital filters to reduce noise and smooth out the signal. The head-worn device can employ a pattern recognition process to analyze the sensor data (which may have been filtered) to identify specific patterns characteristic of a nodding motion. For a double nod, the head-worn device searches for two consecutive vertical movements of the head-down then up, repeated twice in quick succession (e.g., within two seconds). The head-worn device can extract relevant features from the sensor data, such as peak amplitudes, time between peaks, and overall duration of the movement. For a double nod, the head-worn device can search for four distinct peaks in the vertical axis data (two down motions and two up motions) within the specific time frame.

The timing between the two nods can be an important element that the head-worn device analyzes to detect a double nod. The head-worn device analyzes the temporal relationship between the detected movements, ensuring they occur within a predefined time window that's characteristic of an intentional double nod gesture. In some cases, the head-worn device can use the machine learning model to classify head movements. The machine learning model can be trained on datasets of various head gestures to improve accuracy and robustness in distinguishing double nods from other movements.

In response to determining that the double nod was detected concurrently with detecting the verbal cue, the head-worn device automatically generates a listing using the already available listing that has been found on the databases 130. The head-worn device can automatically populate various attributes or options for the listings, such as the price and advertising parameters, using default values. This minimizes the amount of interaction that the user (who may be suffering from dexterity issues) has to perform.

In some cases, the head-worn device can present a list of options with the default values to the user, such as within lenses of the head-worn device and/or on a display screen of the client device 108. The head-worn device can analyze pupils of the user's eyes (e.g., using a camera that is focused on the eyes or face of the user). The head-worn device can determine that the pupils are focused on a particular option that is displayed in the list of options (e.g., an option for configuring an advertising rate). In response to determining that the pupils remain focused on the particular option for a threshold period of time (e.g., three seconds), the head-worn device can activate the option to enable the user to adjust settings associated with the option (e.g., change the advertising rate).

The head-worn device can receive motion information associated with a body part of the user (e.g., eyes or head). For example, the head-worn device can determine, based on the motion information, that the head of the user is being moved in a first direction. The head-worn device, in response to determining, based on the motion information, that the head of the user is being moved in the first direction, can increase the value of the setting. In some examples, the head-worn device can identify a central axis relative to the head-worn device and determine that a normal of the head-worn device is being raised by the head above the central axis by a threshold amount followed by being returned to being aligned with the central axis (within a specified period of one second). The head-worn device can, in response to determining that the normal of the head-worn device is being raised by the head above the central axis by the threshold amount followed by being returned to being aligned with the central axis, increase the value of the setting a first time. Then, the head-worn device can determine that the normal of the head-worn device is again being raised by the head above the central axis by the threshold amount followed by being returned to being aligned with the central axis. In such cases, the head-worn device can, in response to determining that the normal of the head-worn device is again being raised by the head above the central axis by the threshold amount followed by being returned to being aligned with the central axis, increase the value of the setting a second time.

Similarly, the head-worn device can determine, based on the motion information, that the head of the user is being moved in a second direction which may be opposite the first direction. The head-worn device, in response to determining, based on the motion information, that the head of the user is being moved in the second direction, can decrease the value of the setting. In some examples, the head-worn device can identify the central axis relative to the head-worn device and determine that the normal of the head-worn device is being lowered by the head below the central axis by the threshold amount followed by being returned to being aligned with the central axis (within a specified period of one second). The head-worn device can, in response to determining that the normal of the head-worn device is being lowered by the head below the central axis by the threshold amount followed by being returned to being aligned with the central axis, decrease the value of the setting a first time. Then, the head-worn device can determine that the normal of the head-worn device is again being lowered by the head below the central axis by the threshold amount followed by being returned to being aligned with the central axis. In such cases, the head-worn device can, in response to determining that the normal of the head-worn device is again being lowered by the head below the central axis by the threshold amount followed by being returned to being aligned with the central axis, decrease the value of the setting a second time.

In some examples, rather than analyzing head movement or in addition to analyzing head movement, the head-worn device can analyze eye or pupil movement to adjust the settings for the option. For example, the head-worn device can determine, based on the motion information, that the eyes of the user are being moved in a first direction and, in response, increase the value of the setting. Namely, the head-worn device can identify the central axis relative to the head-worn device. The head-worn device can determine that a normal of the eyes is being raised above the central axis by a threshold amount followed by being returned to being aligned with the central axis. The head-worn device can, in response to determining that the normal of the eyes is being raised above the central axis by the threshold amount followed by being returned to being aligned with the central axis, increase the value of the setting a first time. The head-worn device can determine that the normal of the eyes is again being raised above the central axis by the threshold amount followed by being returned to being aligned with the central axis. The head-worn device can, in response to determining that the normal of the eyes is again being raised above the central axis by the threshold amount followed by being returned to being aligned with the central axis, increase the value of the setting a second time.

Similarly, the head-worn device can determine, based on the motion information, that the eyes of the user are being moved in a second direction (opposite the first direction) and, in response, decrease the value of the setting. Namely, the head-worn device can identify the central axis relative to the head-worn device. The head-worn device can determine that a normal of the eyes is being lowered below the central axis by a threshold amount followed by being returned to being aligned with the central axis. The head-worn device can, in response to determining that the normal of the eyes is being lowered below the central axis by the threshold amount followed by being returned to being aligned with the central axis, decrease the value of the setting a first time. The head-worn device can determine that the normal of the eyes is again being lowered below the central axis by the threshold amount followed by being returned to being aligned with the central axis. The head-worn device can, in response to determining that the normal of the eyes is again being lowered below the central axis by the threshold amount followed by being returned to being aligned with the central axis, decrease the value of the setting a second time.

In some examples, the head-worn device can detect a blinking pattern of the eyes or eye lids. For example, the head-worn device can detect that the user is blinking the eyes a specified number of times within a threshold period (e.g., at a certain frequency). In response, the head-worn device can automatically store the current value for the setting in association with the option. Then, the head-worn device can also (concurrently or after or before detecting the blinking pattern) detect a verbal cue (e.g., nonverbal voice input). In such cases, the head-worn device stores the value in association with the setting for the option. Each option that is presented to the user can be adjusted in similar ways, which simplifies the generation and publication of a listing on the electronic marketplace for certain users.

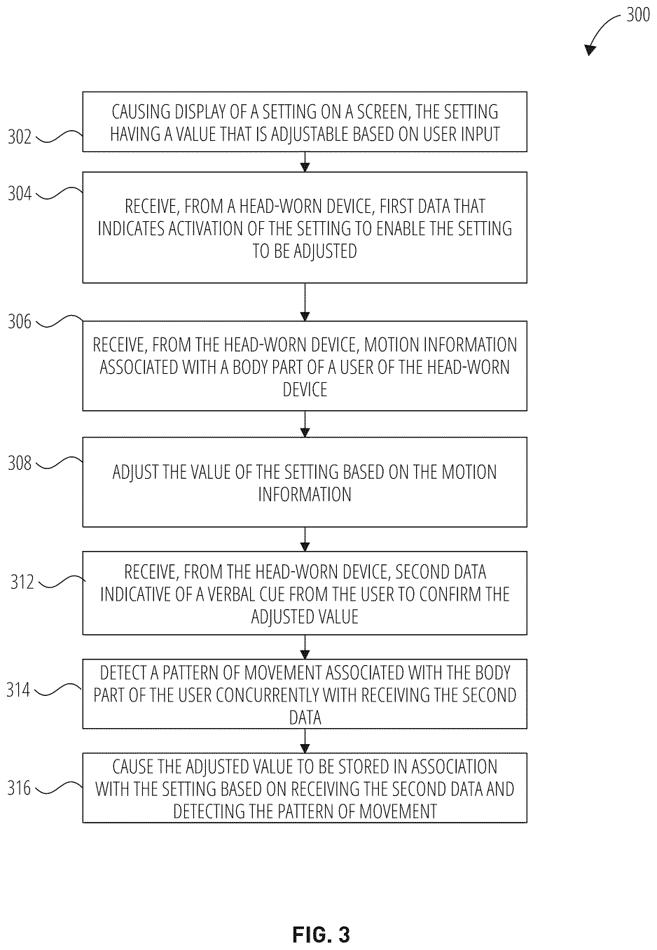

FIG. 3 illustrates a routine 300 (e.g., method or process) in accordance with some examples. The operations discussed in connection with FIG. 3 can be performed sequentially, in parallel, and in any suitable order. The operations discussed in FIG. 3 can be performed by the value adjustment platform 102.

In operation 302, the value adjustment platform 102 causes display of a setting on a screen, the setting having a value that is adjustable based on user input, as discussed above.

In operation 304, the value adjustment platform 102 receives, from a head-worn device, first data that indicates activation of the setting to enable the setting to be adjusted, as discussed above.

In operation 306, the value adjustment platform 102 receives, from the head-worn device, motion information associated with a body part of a user of the head-worn device, as discussed above.

In operation 308, the value adjustment platform 102 adjusts the value of the setting based on the motion information, as discussed above.

In operation 312, the value adjustment platform 102 receives, from the head-worn device, second data indicative of a verbal cue from the user to confirm the adjusted value, as discussed above.

In operation 314, the value adjustment platform 102 detects a pattern of movement associated with the body part of the user concurrently with receiving the second data, as discussed above.

In operation 316, the value adjustment platform 102 causes the adjusted value to be stored in association with the setting based on receiving the second data and detecting the pattern of movement, as discussed above.

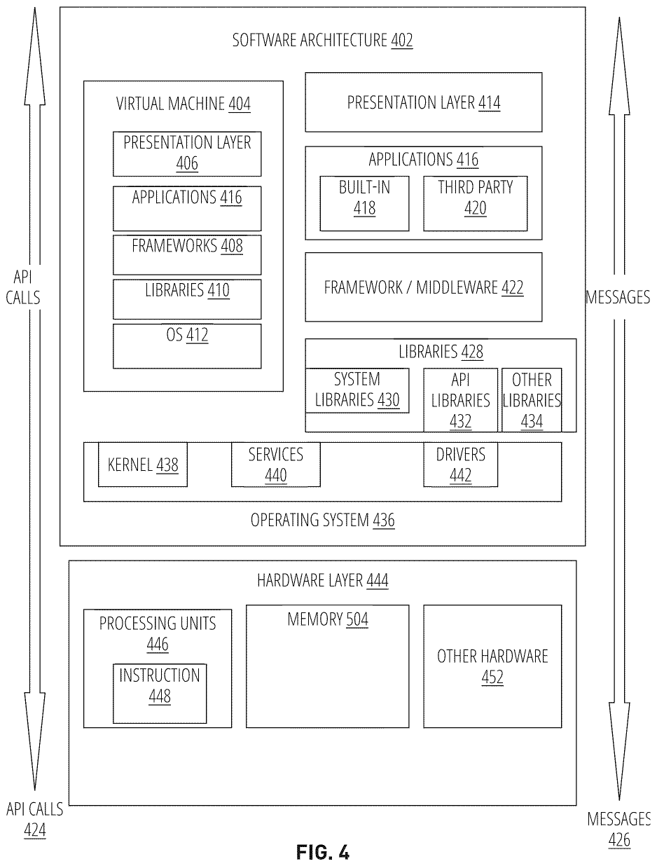

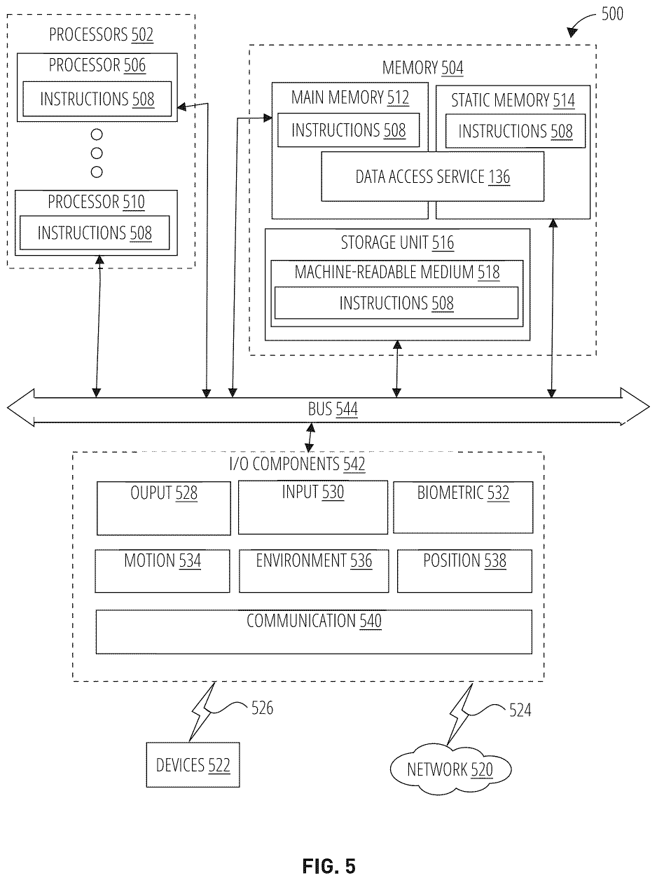

FIG. 4 is a block diagram illustrating an example of a software architecture 402 that may be installed on a machine, according to some examples. FIG. 4 is merely a non-limiting example of a software architecture, and it will be appreciated that many other architectures may be implemented to facilitate the functionality described herein. The software architecture 402 may be executing on hardware such as a machine 500 of FIG. 5 that includes, among other things, processors 510, memory 504, and input/output (I/O) components 542. A representative hardware layer 444 is illustrated and can represent, for example, the machine 500 of FIG. 5. The representative hardware layer 444 comprises one or more processing units 446 having associated executable instructions 448. The executable instructions 448 represent the executable instructions of the software architecture 402. The hardware layer 444 also includes memory 504, which also have the executable instructions 448. The hardware layer 444 may also comprise other hardware 452, which represents any other hardware of the hardware layer 444, such as the other hardware illustrated as part of the machine 500.

The instructions 448 may be transmitted or received over the network using a transmission medium via a network interface device (e.g., a network interface component included in the communication components 540) and utilizing any one of a number of well-known transfer protocols (e.g., hypertext transfer protocol (HTTP)). Similarly, the instructions 448 may be transmitted or received using a transmission medium via the coupling (e.g., a peer-to-peer coupling) to the devices. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 448 for execution by the machine 500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” are non-transitory computer-readable media and specifically exclude carrier waves, modulated data signals, and other such media, at least some of which are covered under the term “signal medium.”

In the example architecture of FIG. 4, the software architecture 402 may be conceptualized as a stack of layers, where each layer provides particular functionality. For example, the software architecture 402 may include layers such as an operating system 436, libraries 428, framework/middleware 422, applications 416, and a presentation layer 414. Operationally, the applications 416 or other components within the layers may invoke API calls API calls 424 through the software stack and receive a response, returned values, and so forth (illustrated as messages 426) in response to the API calls 424. The layers illustrated are representative in nature, and not all software architectures have all layers. For example, some mobile or special-purpose operating systems may not provide a framework/middleware 422 layer, while others may provide such a layer. Other software architectures may include additional or different layers.

The operating system 436 may manage hardware resources and provide common services. The operating system 436 may include, for example, a kernel 438, services 440, and drivers 442. The kernel 438 may act as an abstraction layer between the hardware and the other software layers. For example, the kernel 438 may be responsible for memory management, processor management (e.g., scheduling), component management, networking, security settings, and so on. The services 440 may provide other common services for the other software layers. The drivers 442 may be responsible for controlling or interfacing with the underlying hardware. For instance, the drivers 442 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 428 may provide a common infrastructure that may be utilized by the applications 416 and/or other components and/or layers. The libraries 428 typically provide functionality that allows other software modules to perform tasks in an easier fashion than by interfacing directly with the underlying operating system 436 functionality (e.g., kernel 438, services 440, or drivers 442). The libraries 428 may include system libraries 430 (e.g., C standard library) that may provide functions such as memory allocation functions, string manipulation functions, mathematic functions, and the like. In addition, the libraries 428 may include API libraries 432 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 428 may also include a wide variety of other libraries 434 to provide many other APIs to the applications 416 and other software components/modules.

The frameworks/middleware 422 (also sometimes referred to as middleware) may provide a higher-level common infrastructure that may be utilized by the applications 416 or other software components/modules. For example, the frameworks/middleware 422 may provide various graphical user interface functions, high-level resource management, high-level location services, and so forth. The frameworks/middleware 422 may provide a broad spectrum of other APIs that may be utilized by the applications 416 and/or other software components/modules, some of which may be specific to a particular operating system or platform.

The applications 416 include built-in applications 418 and/or third-party applications 420. Examples of representative built-in applications 418 may include, but are not limited to, a home application, a contacts application, a browser application, a book reader application, a location application, a media application, a messaging application, or a game application.

The third-party applications 420 may include any of the built-in applications 418, as well as a broad assortment of other applications. In a specific example, the third-party applications 420 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 420 may invoke the API calls 424 provided by the mobile operating system such as the operating system 436 to facilitate functionality described herein.

The applications 416 may utilize built-in operating system functions (e.g., kernel 438, services 440, or drivers 442), libraries (e.g., system libraries 430, API libraries 432, and other libraries 434), or framework/middleware 422 to create user interfaces to interact with users of the system. Alternatively, or additionally, in some systems, interactions with a user may occur through a presentation layer, such as the presentation layer 414. In these systems, the application/module “logic” can be separated from the aspects of the application/module that interact with the user.

Some software architectures utilize virtual machines. In the example of FIG. 4, this is illustrated by a virtual machine 404. The virtual machine 404 creates a software environment where applications/modules can execute as if they were executing on a hardware machine (e.g., the machine 500 of FIG. 5). The virtual machine 404 is hosted by a host operating system (e.g., the operating system 436) and typically, although not always, has a virtual machine monitor, which manages the operation of the virtual machine 404 as well as the interface with the host operating system (e.g., the operating system 436). A software architecture executes within the virtual machine 404, such as an operating system 412, libraries 410, frameworks 408, applications 416, or a presentation layer 406. These layers of software architecture executing within the virtual machine 404 can be the same as corresponding layers previously described or may be different.

FIG. 5 is a diagrammatic representation of the machine 500 within which instructions 508 (e.g., software, a program, an application, an applet, an app, or other executable code) for causing the machine 500 to perform any one or more of the methodologies discussed herein may be executed. For example, the instructions 508 may cause the machine 500 to execute any one or more of the methods described herein. The instructions 508 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 508, sequentially or otherwise, that specify actions to be taken by the machine 500. Further, while only a single machine 500 is illustrated, the term “machine” shall also be taken to include a collection of machines that individually or jointly execute the instructions 508 to perform any one or more of the methodologies discussed herein.

The machine 500 may include processors 502, memory 504, and I/O components 542, which may be configured to communicate with each other via a bus 544. In an example, the processors 502 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 506 and a processor 510 that execute the instructions 508. The term “processor” is intended to include multi-core processors that may comprise two or more independent processors (sometimes referred to as “cores”) that may execute instructions contemporaneously. Although FIG. 5 shows multiple processors 502, the machine 500 may include a single processor with a single core, a single processor with multiple cores (e.g., a multi-core processor), multiple processors with a single core, multiple processors with multiples cores, or any combination thereof.

The memory 504 includes a main memory 512, a static memory 514, and a storage unit 516, both accessible to the processors 502 via the bus 544. The main memory 504, the static memory 514, and storage unit 516 store the instructions 508 embodying any one or more of the methodologies or functions described herein. The instructions 508 may also reside, completely or partially, within the main memory 512, within the static memory 514, within machine-readable medium 518 within the storage unit 516, within at least one of the processors 502 (e.g., within the processor's cache memory), or any suitable combination thereof, during execution thereof by the machine 500.

The I/O components 542 may include a wide variety of components to receive input, provide output, produce output, transmit information, exchange information, capture measurements, and so on. The specific I/O components 542 that are included in a particular machine will depend on the type of machine. For example, portable machines such as mobile phones may include a touch input device or other such input mechanisms, while a headless server machine will likely not include such a touch input device. It will be appreciated that the I/O components 542 may include many other components that are not shown in FIG. 5. In various examples, the I/O components 542 may include output components 528 and input components 530. The output components 528 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 530 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 542 may include biometric components 532, motion components 534, environmental components 536, or position components 538, among a wide array of other components. For example, the biometric components 532 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 534 include acceleration sensor components (e.g., accelerometer), gravitation sensor components, rotation sensor components (e.g., gyroscope), and so forth. The environmental components 536 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 538 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 542 further include communication components 540 operable to couple the machine 500 to a network 520 or devices 522 via a coupling 524 and a coupling 526, respectively. For example, the communication components 540 may include a network interface component or another suitable device to interface with the network 520. In further examples, the communication components 540 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 522 may be another machine or any of a wide variety of peripheral devices (e.g., a peripheral device coupled via a USB).

Moreover, the communication components 540 may detect identifiers or include components operable to detect identifiers. For example, the communication components 540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 540, such as location via Internet Protocol (IP) geolocation, location via Wi-Fi® signal triangulation, location via detecting an NFC beacon signal that may indicate a particular location, and so forth.

The various memories (e.g., memory 504, main memory 512, static memory 514, and/or memory of the processors 502) and/or storage unit 516 may store one or more sets of instructions and data structures (e.g., software) embodying or used by any one or more of the methodologies or functions described herein. These instructions (e.g., the instructions 508), when executed by processors 502, cause various operations to implement the disclosed examples.

The instructions 508 may be transmitted or received over the network 520, using a transmission medium, via a network interface device (e.g., a network interface component included in the communication components 540) and using any one of a number of well-known transfer protocols (e.g., hypertext transfer protocol (HTTP)). Similarly, the instructions 508 may be transmitted or received using a transmission medium via the coupling 526 (e.g., a peer-to-peer coupling) to the devices 522.

Although examples have been described, it will be evident that various modifications and changes may be made to these examples without departing from the broader scope of the present disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

In view of the disclosure above, various examples are set forth below. It should be noted that one or more features of an example, taken in isolation or combination, should be considered within the disclosure of this application.

Example 1. A system comprising: one or more hardware processors; and at least one machine-storage medium for storing instructions that, when executed by the one or more hardware processors, cause the one or more hardware processors to perform operations comprising: displaying a setting on a screen, the setting having a value that is adjustable based on user input; receiving, from a head-worn device, first data that indicates activation of the setting to enable the setting to be adjusted; receiving, from the head-worn device, motion information associated with a body part of a user of the head-worn device; adjusting the value of the setting based on the motion information; receiving, from the head-worn device, second data indicative of a verbal cue from the user to confirm the adjusted value; detecting a pattern of movement associated with the body part of the user concurrently with receiving the second data; and causing the adjusted value to be stored in association with the setting based on receiving the second data and detecting the pattern of movement.

Example 2. The system of Example 1, wherein the operations comprise: automatically generating a listing for an item in a field of view of the head-worn device; publishing the listing on a publication platform, wherein the setting comprises a rate selection for setting a rate for publishing the listing on the publication platform; presenting a first option to increase the value of the setting; presenting a second option to decrease the value for the setting; and selecting between the first option and the second option based on the motion information.

Example 3. The system of Example 2, wherein the body part comprises a head of the user, and wherein the operations comprise: determining, based on the motion information, that the head of the user is being moved in a first direction; and in response to determining, based on the motion information, that the head of the user is being moved in the first direction, increasing the value of the setting.

Example 4. The system of Example 3, wherein the operations comprise: identifying a central axis relative to the head-worn device; determining that a normal of the head-worn device is being raised by the head above the central axis by a threshold amount followed by being returned to being aligned with the central axis; in response to determining that the normal of the head-worn device is being raised by the head above the central axis by the threshold amount followed by being returned to being aligned with the central axis, increasing the value of the setting a first time; determining that the normal of the head-worn device is again being raised by the head above the central axis by the threshold amount followed by being returned to being aligned with the central axis; and in response to determining that the normal of the head-worn device is again being raised by the head above the central axis by the threshold amount followed by being returned to being aligned with the central axis, increasing the value of the setting a second time.

Example 5. The system of Example 4, wherein the operations comprise: determining that the motion information represents a double nod of the head, the double nod of the head comprising moving the head above or below the central axis a certain number of times within a specified interval; and in response to determining that the motion information represents the double nod of the head, storing the adjusted value for the setting after receiving the verbal cue.

Example 6. The system of Example 5, wherein the operations comprise: presenting audible feedback to the user indicating the adjusted value; and receiving the verbal cue confirming the adjusted value following the audible feedback.

Example 7. The system of any one of Examples 2-6, wherein the body part comprises eyes of the user, and wherein the operations comprise: determining, based on the motion information, that the eyes of the user are being moved in a first direction; and in response to determining, based on the motion information, that the eyes of the user are being moved in the first direction, increasing the value of the setting.

Example 8. The system of Example 7, wherein the operations comprise: identifying a central axis relative to the head-worn device; determining that a normal of the eyes is being raised above the central axis by a threshold amount followed by being returned to being aligned with the central axis; in response to determining that the normal of the eyes is being raised above the central axis by the threshold amount followed by being returned to being aligned with the central axis, increasing the value of the setting a first time; determining that the normal of the eyes is again being raised above the central axis by the threshold amount followed by being returned to being aligned with the central axis; and in response to determining that the normal of the eyes is again being raised above the central axis by the threshold amount followed by being returned to being aligned with the central axis, increasing the value of the setting a second time.

Example 9. The system of Example 8, wherein the operations comprise: determining that a blinking pattern of the eyes corresponds to a specified pattern; and in response to determining that the blinking pattern of the eyes corresponds to the specified pattern, storing the adjusted value for the setting after receiving the verbal cue.

Example 10. The system of any one of Examples 1-9, wherein the operations comprise: applying a combination of object segmentation and haptic and verbal cues to activate the setting for adjustment.

Example 11. The system of Example 10, wherein the pattern of movement comprises a double nod of a head, where the head is moved up and down multiple times within a specified threshold period of time.

Example 12. The system of Example 11, wherein the verbal cue comprises one or more nonverbal sounds.

Example 13. A method comprising: displaying, by one or more hardware processors, a setting on a screen, the setting having a value that is adjustable based on user input; receiving, from a head-worn device, first data that indicates activation of the setting to enable the setting to be adjusted; receiving, from the head-worn device, motion information associated with a body part of a user of the head-worn device; adjusting the value of the setting based on the motion information; receiving, from the head-worn device, second data indicative of a verbal cue from the user to confirm the adjusted value; detecting a pattern of movement associated with the body part of the user concurrently with receiving the second data; and causing the adjusted value to be stored in association with the setting based on receiving the second data and detecting the pattern of movement.

Example 14. The method of Example 13, further comprising: automatically generating a listing for an item in a field of view of the head-worn device; publishing the listing on a publication platform, wherein the setting comprises a rate selection for setting a rate for publishing the listing on the publication platform; presenting a first option to increase the value of the setting; presenting a second option to decrease the value for the setting; and selecting between the first option and the second option based on the motion information.

Example 15. The method of Example 14, wherein the body part comprises a head of the user, and further comprising: determining, based on the motion information, that the head of the user is being moved in a first direction; and in response to determining, based on the motion information, that the head of the user is being moved in the first direction, increasing the value of the setting.

Example 16. The method of Example 15, further comprising: identifying a central axis relative to the head-worn device; determining that a normal of the head-worn device is being raised by the head above the central axis by a threshold amount followed by being returned to being aligned with the central axis; in response to determining that the normal of the head-worn device is being raised by the head above the central axis by the threshold amount followed by being returned to being aligned with the central axis, increasing the value of the setting a first time; determining that the normal of the head-worn device is again being raised by the head above the central axis by the threshold amount followed by being returned to being aligned with the central axis; and in response to determining that the normal of the head-worn device is again being raised by the head above the central axis by the threshold amount followed by being returned to being aligned with the central axis, increasing the value of the setting a second time.

Example 17. The method of Example 16, further comprising: determining that the motion information represents a double nod of the head, the double nod of the head comprising moving the head above or below the central axis a certain number of times within a specified interval; and in response to determining that the motion information represents the double nod of the head, storing the adjusted value for the setting after receiving the verbal cue.

Example 18. The method of Example 17, further comprising: presenting audible feedback to the user indicating the adjusted value; and receiving the verbal cue confirming the adjusted value following the audible feedback.

Example 19. The method of any one of Examples 14-18, wherein the body part comprises eyes of the user, and further comprising: determining, based on the motion information, that the eyes of the user are being moved in a first direction; and in response to determining, based on the motion information, that the eyes of the user are being moved in the first direction, increasing the value of the setting.

Example 20. A machine-storage medium for storing instructions that, when executed by one or more hardware processors, cause the one or more hardware processors to perform operations comprising: displaying a setting on a screen, the setting having a value that is adjustable based on user input; receiving, from a head-worn device, first data that indicates activation of the setting to enable the setting to be adjusted; receiving, from the head-worn device, motion information associated with a body part of a user of the head-worn device; adjusting the value of the setting based on the motion information; receiving, from the head-worn device, second data indicative of a verbal cue from the user to confirm the adjusted value; detecting a pattern of movement associated with the body part of the user concurrently with receiving the second data; and causing the adjusted value to be stored in association with the setting based on receiving the second data and detecting the pattern of movement.

1. A system comprising:
one or more hardware processors; and
at least one machine-storage medium for storing instructions that, when executed by the one or more hardware processors, cause the one or more hardware processors to perform operations comprising:
causing display of a setting on a screen, the setting having a value that is adjustable based on user input;
receiving, from a head-worn device, first data that indicates activation of the setting to enable the setting to be adjusted, the receiving of the first data that indicates activation comprising:
analyzing by the head-worn device, content that is displayed on the screen to identify one or more options on the screen; and
determining that pupils of a user are focused on a particular option of the one or more options that have been identified and that the pupils remain focused on the particular option for a threshold period of time, the particular option corresponding to the setting;
receiving, from the head-worn device, motion information associated with a body part of a user of the head-worn device;
adjusting the value of the setting based on the motion information;
receiving, from the head-worn device, second data indicative of a verbal cue from the user to confirm the adjusted value;
detecting a pattern of movement associated with the body part of the user concurrently with receiving the second data; and
causing the adjusted value to be stored in association with the setting based on receiving the second data and detecting the pattern of movement.

2. The system of claim 1, wherein the operations comprise:
automatically generating a listing for an item in a field of view of the head-worn device;
publishing the listing on a publication platform, wherein the setting comprises a rate selection for setting a rate for publishing the listing on the publication platform;
presenting a first option to increase the value of the setting;
presenting a second option to decrease the value for the setting; and
selecting between the first option and the second option based on the motion information.

3. The system of claim 2, wherein the body part comprises a head of the user, and wherein the operations comprise:
determining, based on the motion information, that the head of the user is being moved in a first direction; and
in response to determining, based on the motion information, that the head of the user is being moved in the first direction, increasing the value of the setting.

4. The system of claim 3, wherein the operations comprise:
identifying a central axis relative to the head-worn device;
determining that a normal of the head-worn device is being raised by the head above the central axis by a threshold amount followed by being returned to being aligned with the central axis;
in response to determining that the normal of the head-worn device is being raised by the head above the central axis by the threshold amount followed by being returned to being aligned with the central axis, increasing the value of the setting a first time;
determining that the normal of the head-worn device is again being raised by the head above the central axis by the threshold amount followed by being returned to being aligned with the central axis; and
in response to determining that the normal of the head-worn device is again being raised by the head above the central axis by the threshold amount followed by being returned to being aligned with the central axis, increasing the value of the setting a second time.

5. The system of claim 4, wherein the operations comprise:
determining that the motion information represents a double nod of the head, the double nod of the head comprising moving the head above or below the central axis a certain number of times within a specified interval; and
in response to determining that the motion information represents the double nod of the head, storing the adjusted value for the setting after receiving the verbal cue.

6. The system of claim 5, wherein the operations comprise:
presenting audible feedback to the user indicating the adjusted value; and
receiving the verbal cue confirming the adjusted value following the audible feedback.

7. The system of claim 2, wherein the body part comprises eyes of the user, and wherein the operations comprise:
determining, based on the motion information, that the eyes of the user are being moved in a first direction; and
in response to determining, based on the motion information, that the eyes of the user are being moved in the first direction, increasing the value of the setting.

8. The system of claim 7, wherein the operations comprise:
identifying a central axis relative to the head-worn device;
determining that a normal of the eyes is being raised above the central axis by a threshold amount followed by being returned to being aligned with the central axis;
in response to determining that the normal of the eyes is being raised above the central axis by the threshold amount followed by being returned to being aligned with the central axis, increasing the value of the setting a first time;
determining that the normal of the eyes is again being raised above the central axis by the threshold amount followed by being returned to being aligned with the central axis; and
in response to determining that the normal of the eyes is again being raised above the central axis by the threshold amount followed by being returned to being aligned with the central axis, increasing the value of the setting a second time.

9. The system of claim 8, wherein the operations comprise:
determining that a blinking pattern of the eyes corresponds to a specified pattern; and
in response to determining that the blinking pattern of the eyes corresponds to the specified pattern, storing the adjusted value for the setting after receiving the verbal cue.

10. The system of claim 1, wherein the operations comprise:
applying a combination of object segmentation and haptic and verbal cues to activate the setting for adjustment.

11. The system of claim 10, wherein the pattern of movement comprises a double nod of a head, where the head is moved up and down multiple times within a specified threshold period of time.

12. The system of claim 1, wherein the user input for adjusting the value comprises non-touch input, and wherein the verbal cue comprises one or more nonverbal sounds.

13. A method comprising:
causing display of, by one or more hardware processors, a setting on a screen, the setting having a value that is adjustable based on user input;
receiving, from a head-worn device, first data that indicates activation of the setting to enable the setting to be adjusted, the receiving of the first data that indicates activation comprising:
analyzing, by the head-worn device, content that is displayed on the screen to identify one or more options on the screen; and
determining that pupils of a user are focused on a particular option of the one or more options that have been identified and that the pupils remain focused on the particular option for a threshold period of time, the particular option corresponding to the setting;
receiving, from the head-worn device, motion information associated with a body part of a user of the head-worn device;
adjusting the value of the setting based on the motion information;
receiving, from the head-worn device, second data indicative of a verbal cue from the user to confirm the adjusted value;
detecting a pattern of movement associated with the body part of the user concurrently with receiving the second data; and
causing the adjusted value to be stored in association with the setting based on receiving the second data and detecting the pattern of movement.

14. The method of claim 13, further comprising:
automatically generating a listing for an item in a field of view of the head-worn device; and
publishing the listing on a publication platform, wherein the setting comprises a rate selection for setting a rate for publishing the listing on the publication platform.

15. The method of claim 14, further comprising:
presenting a first option to increase the value of the setting:
presenting a second option to decrease the value for the setting; and
selecting between the first option and the second option based on the motion information.

16. The method of claim 15, wherein the body part comprises a head of the user, and further comprising:
determining, based on the motion information, that the head of the user is being moved in a first direction;
in response to determining, based on the motion information, that the head of the user is being moved in the first direction, increasing the value of the setting;
identifying a central axis relative to the head-worn device;
determining that a normal of the head-worn device is being raised by the head above the central axis by a threshold amount followed by being returned to being aligned with the central axis;
in response to determining that the normal of the head-worn device is being raised by the head above the central axis by the threshold amount followed by being returned to being aligned with the central axis, increasing the value of the setting a first time;
determining that the normal of the head-worn device is again being raised by the head above the central axis by the threshold amount followed by being returned to being aligned with the central axis; and
in response to determining that the normal of the head-worn device is again being raised by the head above the central axis by the threshold amount followed by being returned to being aligned with the central axis, increasing the value of the setting a second time.

17. The method of claim 16, further comprising:
determining that the motion information represents a double nod of the head, the double nod of the head comprising moving the head above or below the central axis a certain number of times within a specified interval; and
in response to determining that the motion information represents the double nod of the head, storing the adjusted value for the setting after receiving the verbal cue.

18. The method of claim 17, further comprising:
presenting audible feedback to the user indicating the adjusted value; and
receiving the verbal cue confirming the adjusted value following the audible feedback.

19. The method of claim 14, wherein the body part comprises eyes of the user, and further comprising:
determining, based on the motion information, that the eyes of the user are being moved in a first direction, and
in response to determining, based on the motion information, that the eyes of the user are being moved in the first direction, increasing the value of the setting.

20. A machine-storage medium for storing instructions that, when executed by one or more hardware processors, cause the one or more hardware processors to perform operations comprising:
causing display of a setting on a screen, the setting having a value that is adjustable based on user input;
receiving, from a head-worn device, first data that indicates activation of the setting to enable the setting to be adjusted, the receiving of the first data that indicates activation comprising:
analyzing, by the head-worn device, content that is displayed on the screen to identify one or more options on the screen; and
determining that pupils of a user are focused on a particular option of the one or more options that have been identified and that the pupils remain focused on the particular option for a threshold period of time, the particular option corresponding to the setting;
receiving, from the head-worn device, motion information associated with a body part of a user of the head-worn device;
adjusting the value of the setting based on the motion information;
receiving, from the head-worn device, second data indicative of a verbal cue from the user to confirm the adjusted value;
detecting a pattern of movement associated with the body part of the user concurrently with receiving the second data; and
causing the adjusted value to be stored in association with the setting based on receiving the second data and detecting the pattern of movement.
